(19) United States
(12) Patent Application Publication
(10) Pub. No.: US 2012/0205048 A1
(43) Pub. Date: Aug. 16, 2012

(54) WIND TURBINE BLADE AUTOMATED PRODUCTION SYSTEM

(75) Inventor: Gabriel Mironov, Montreal (CA)

(73) Assignee: Suzhou Red Maple Wind Blade Mould Co., Ltd., Jiangsu (CN)

(21) Appl. No.: 13/497,845

(22) PCT Filed: Sep. 20, 2010
(86) PCT No.: PCT/CN2010/001448

§ 371 Date: May 4, 2012

(30) Foreign Application Priority Data
Sep. 23, 2009 (CN) 200910175883.9

(51) Int. Cl. G05G 17/00; G05G 15/00

(52) U.S. Cl. 156/365; 156/350

(57) ABSTRACT

A wind turbine blade automated production system, characterized in that the system comprising a fixed side mould, a turning side mould, at least a fixed side mould gantry spanning over the fixed side mould and at least a turning side mould gantry (9) spanning over the turning side mould, wherein each gantry is supported on an outer track and an inner track, so that each gantry is slidable along the longitudinal direction of the moulds, wherein the turning side mould is provided with a plurality of turnover hinge devices (12), wherein the inner track is provided with a plurality of gaps (10), the number and the position of which correspond to the number and the position of the turnover hinge devices (12), and the inner track is arranged at such a height that the turnover hinge devices (12) may rotate the turning side mould without any collision of the mould and the inner track.

### TECHNICAL FIELD

The present invention relates to a wind turbine blade automated production system.

### BACKGROUND

As the quantity of wind turbine blades produced annually has increased, efforts have been made to automate the blade production process by use of robots to do some of the production work. It has widely been discussed that robots could be applied to:

1. Spray gelcoat in the blade mould.

2. Place the dry fiberglass.

3. Apply bonding adhesive to the blade halves before joining them to make the complete blade.

A practical problem arises in discussion of where to place the robot.

Due to the size of the moulds, the robot obviously must be on a car or trolley of some sort. However there is no location on the floor where a track can be conveniently situated to allow full access to the blade mould. Moreover, a robot mounted from the bottom side cannot reach into the blade mould without passing over the worker platform and potentially striking or injuring workers.

The above considerations encourage placing the robot on a gantry over the mould, similar in structure to an ordinary factory overhead crane. However, in such case the gantry must span over both moulds. It is not possible to use a separate gantry for each mould, since the mould turnover system would collide with the inner track provided for the gantry movement. It is generally not practical to use two robots on one wide gantry, spanning both moulds, to produce the halves of the blade at exactly the same time. This is because the two halves of the blade usually have different lamination structures and different numbers of layers of composite material.

### SUMMARY OF THE INVENTION

The present invention has been accomplished in order to solve the above-mentioned problem.

A wind turbine blade automated production system, characterized in that the system comprising a fixed side mould, a turning side mould, at least a fixed side mould gantry spanning over the fixed side mould and at least a turning side mould gantry spanning over the turning side mould, wherein each gantry is supported on an outer track and an inner track, so that each gantry is slidable along the longitudinal direction of the moulds; wherein the turning side mould is provided with a plurality of turnover hinge devices; wherein the inner track is provided with a plurality of gaps, the number and the postion of which correspond to the number and the postion of the turnover hinge devices, and the inner track is arranged at such a height that the turnover hinge devices may rotate the turning side mould without any collision of the mould and the inner track. In this way it is possible to arrange two narrower gantries, with one independently operating over each mould.

In a preferred embodiment, each gantry is provided with a robot.

In a preferred embodiment, the inner track is provided with a plurality of removeable bridge sections, which can be moved between a first or closed position in which the bridge sections fill the gaps whenever the gantries will pass over, and a second or removed position in which the bridge sections are moved out of way so that the hinge devices can pass through the gaps whenever the moulds will be opened or closed.

In an alternative embodiment, each gantry is provided with 3 or more wheels on the inner side, the distance between any two wheels being larger than the gap, with at least two wheels supported at all times, so that the gantry can ride over the open gap without losing support at any moment. In such a case, the removeable bridge sections are not required.

### BRIEF DESCRIPTION OF THE DRAWINGS

The present invention will now be described in detail by way of non-limiting example and with reference to the accompanying drawings, wherein:

FIG. 1 is an end view showing a wind turbine blade automated production system with gantries according to the present invention.

FIG. 2 is a perspective view showing the wind turbine blade automated production system.

FIG. 3 is a closeup view showing the wind turbine blade automated production system.

FIG. 4 is another closeup view showing the wind turbine blade automated production system.

FIG. 5 is a schematic view showing a perferred embodiment of the gantry of the wind turbine blade automated production system.

### PREFERRED EMBODIMENT

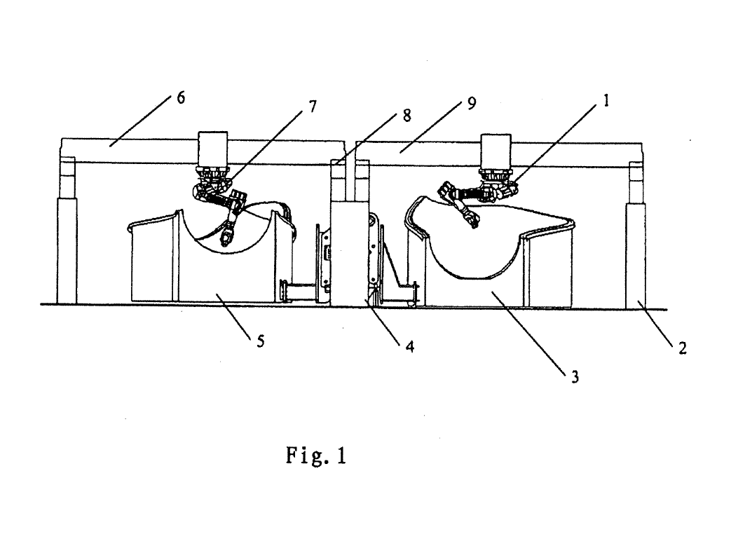

As shown in FIG. 1, a wind turbine blade automated production system according to the present invention comprises a fixed side mould 5, a turning side mould 3, a fixed side mould gantry 6 spanning over the fixed side mould 5 and a turning side mould gantry 9 spanning over the turning side mould 3. Each gantry is provided with a robot fixed near the middle of the gantry, i.e. a fixed side mould robot 1 and a turning side mould robot 7. Thus, it is possible to produce the halves of the blade in the moulds at exactly the same time. Each gantry is supported at an outer side thereof on an outer track supported by an outer support column 2 and at an inner side thereof on an inner track 8 supported by an inner support column 4, so that each gantry is slidable on the outer and inner tracks along the longitudinal direction of the moulds. The turning side mould 3 is provided with a plurality of turnover hinge devices 12, preferably 2˜7. In FIG. 1, the robots 1 and 7 are shown in operation.

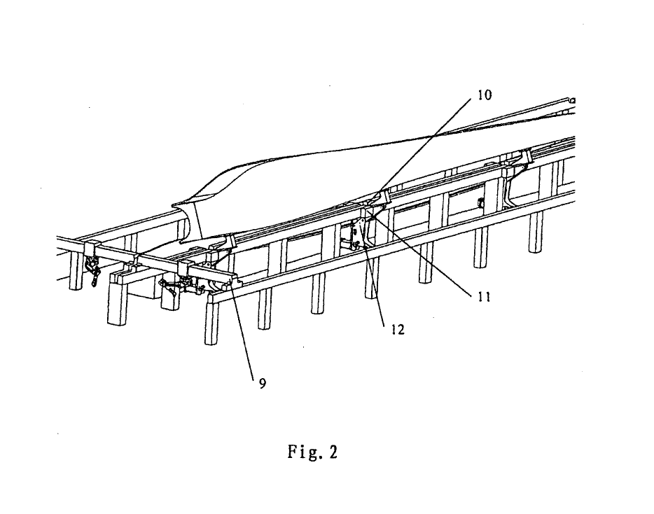

As shown in FIGS. 2-4, the inner track 8 is provided with a plurality of gaps 10, the number and the postion of which correspond to the number and the postion of the turnover hinge devices 12. The inner track 8 is arranged at such a height that the turnover hinge devices 12 may rotate the turning side mould 3 without any collision of the mould and the inner track. The inner track 8 is provided with a plurality of removeable bridge sections 11, which can be moved between a first position and a second position. In the first position or closed position, the bridge sections 11 fill the gaps whenever the gantries will pass over. In the second position or removed position, the bridge sections 11 are moved out of way so that the hinge devices 12 can pass through the gaps whenever the moulds will be opened or closed. In this case, the opening or closing of the moulds is achieved by the turnover of the turning side mould 3. The removeable bridge sections 11 are moved by using e.g. an electric motor and gearbox whenever the mould will be opened or closed. FIG. 2 shows that the gantries 6, 9 with robots 1, 7 are moved out of the way, the removeable bridge sections 11 are removed to the open position, the gaps 10 are open, the turning side mould 3 is turning over, and the mould turnover hinge devices 12 are passing through the gaps 10.

Power is supplied to the gantries 6, 9 on the outer side, away from the turnover hinge devices 12. The gantries 6, 9 are provided with servo drive motors on each side to achieve the movement. A PLC (programmable logical controller) system is provided to create an interlock between the removeable bridge sections 11 and the gantries, in order to prevent any operation of the gantries while the removeable bridge sections 11 are removed.

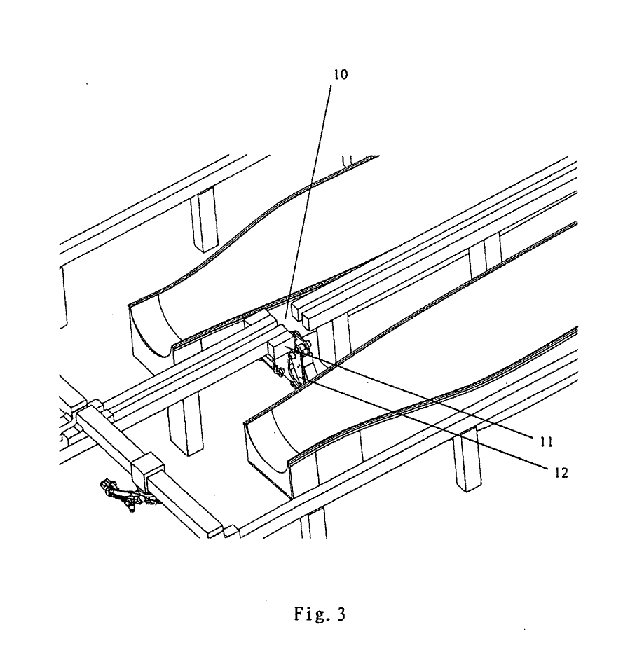

As shown in the closeup view of FIG. 3, the bridge sections 11 are removed, and the turnover hinge is ready to be used.

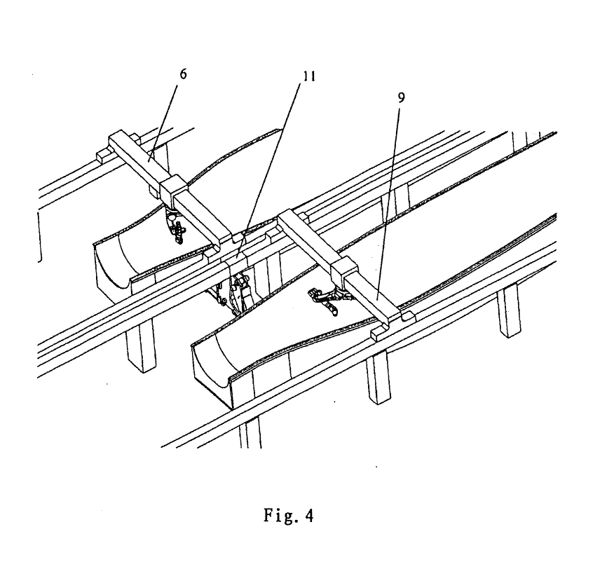

As shown in FIG. 4, the gantries 6, 9 are working and the gaps 10 are closed, the bridge sections 11 are in the closed position, and the tuning side mould gantry 9 is in a different postion from the fixed side mould gantry 6, i.e. the two gantries are not in synchronation.

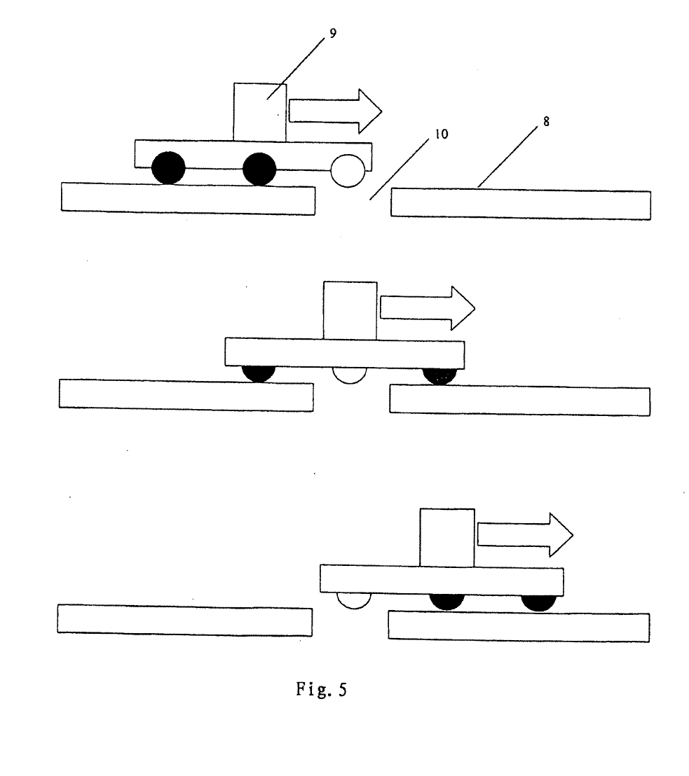

FIG. 5 schematically shows an alternative embodiment. For sake of simplicity, only the turning side mould gantry 9 is shown in FIG. 5. Each gantry 6, 9 may be provided with 3 or more wheels on the inner side, the distance between any two wheels being larger than the gap, with at least two wheels supported at all times, so that the load can be transferred from one wheel to another and the gantry can ride over the open gap without losing support at any moment. In such a case, the removeable bridge sections are not required. For reasons of easier machine control and longer life of the wheels, it is preferred to use the drawbridge arrangement.

Various other embodiments are conceivable, such as:

1. Using more than 1 gantry over each mould.

2. Using other types of cars on the track instead of a gantry, in order to carry mixing machines, raw material, etc.

3. Installing and removing the bridge sections of the inner track by other means, such as using hydraulic cylinders, various mechanical linkages, etc.

Within the scope and spirit of the present invention, one skilled in the art will understand that various changes and modifications can be made.

1. A wind turbine blade automated production system, characterized in that the system comprising a fixed side mould, a turning side mould, at least a fixed side mould gantry spanning over the fixed side mould and at least a turning side mould gantry spanning over the turning side mould,
wherein each gantry is supported on an outer track and an inner track, so that each gantry is slidable along the longitudinal direction of the moulds;
wherein the turning side mould is provided with a plurality of turnover hinge devices;
wherein the inner track is provided with a plurality of gaps, the number and the position of which correspond to the number and the position of the turnover hinge devices, and the inner track is arranged at such a height that the turnover hinge devices may rotate the turning side mould without any collision of the mould and the inner track.

2. The wind turbine blade automated production system according to claim 1, characterized in that each gantry is provided with a robot.

3. The wind turbine blade automated production system according to claim 1, characterized in that the inner track is provided with a plurality of removeable bridge sections, which can be moved between a first position in which the bridge sections fill the gaps whenever the gantries will pass over, and a second position in which the bridge sections are moved out of way so that the hinge devices can pass through the gaps whenever the moulds will be opened or closed.

4. The wind turbine blade automated production system according to claim 1, characterized in that each gantry is provided with 3 or more wheels on the inner side, the distance between any two wheels being larger than the gap, with at least two wheels supported at all times, so that the gantry can ride over the open gap without losing support at any moment.

5. The wind turbine blade automated production system according to claim 3, characterized in that a PLC system is provided to create an interlock between the removeable bridge sections and the gantries, in order to prevent any operation of the gantries while the removeable bridge sections are removed.
